(19) United States
(12) Patent Application Publication
(10) Pub. No.: US 2011/0276375 A1
(43) Pub. Date: Nov. 10, 2011

(54) METHOD AND SYSTEM FOR OBTAINING REFERRALS

(76) Inventor: Merrit Strunk, (US)

(21) Appl. No.: 12/896,631

(22) Filed: Oct. 1, 2010

Related U.S. Application Data
(60) Provisional application No. 61/331,468, filed on May 5, 2010.

(51) Int. Cl. G06Q 30/00

(52) U.S. Cl. 705/14.16; 705/1.1

(57) ABSTRACT

Web-based methods and systems enable businesses to obtain customer referrals from customers. Businesses may offer incentives to customers to provide information on prospective customers. The business may then contact the prospective customer and request approval to market to the prospective customer. The prospective customer may indicate approval, permitting the business to market to them directly.

### CROSS-REFERENCE TO RELATED APPLICATIONS

This application claims priority to U.S. Provisional Patent Application No. 61/331,468, filed May 5, 2010, which is hereby incorporated by reference herein in its entirety.

### FIELD OF INVENTION

The present invention relates generally, to marketing and specifically, to computer implemented methods and systems for obtaining new customer referrals.

### BACKGROUND OF THE INVENTION

Traditionally, word of mouth marketing and customer referrals have been widely used and can be, occasionally, somewhat effective marketing strategies. For example, a current or past customer may discuss goods or services purchased from a business with friends and family. These discussions may potentially influence the customer's friends and family to also become customers of the business. In this regard, referrals of new customers by past or current customers represent a significant source of new business. In addition, such referrals may be particularly beneficial to service-based industries, such as insurance agencies and financial service providers.

Many businesses facilitate word of mouth and referral marketing by offering different types of incentives to past and current customers for referring potential customers. For example, a business may pay a referral bonus to current customers if a person referred by the current customer purchases products or services from the business.

Traditional marketing methods have evolved as the internet has become more prominent in consumers' lives. Both word of mouth and referral marketing are utilized by businesses in relation internet based marketing. Existing customers of businesses may communicate electronically, via email, with friends and family regarding their experiences with the business. Businesses may provide incentives for past and existing customers to send such electronic communications. Such marketing methods have become an important part of many businesses' marketing strategies.

Marketing strategies such as word of mouth and referral programs are more passive than other methods, such as direct marketing. Direct marketing allows a business to target particular prospective customers. Businesses may determine the type and number of prospective customers they communicate with, as well as the manner in which they communicate with them. In contrast, referral programs depend on the actions of customers. As a result, many businesses also utilize direct marketing strategies.

A common direct marketing strategy involves sending electronic communications, such as email, directly to potential customers. There are a number of potential problems associated with using email to directly market customers, however. Unsolicited commercial emails, often referred to as spam, must comply with a number of legal requirements. In addition, spam messages are highly disfavored by many consumers and may create a negative perception of the business sending the spam.

Therefore, what is needed is a system that can combine the positive benefits of referral-based marketing with the ability to directly market prospective customers.

### SUMMARY OF THE INVENTION

The present invention provides a method and system for obtaining new customer referrals. In accordance with various embodiments of the invention, a business may contact existing customers to obtain information relating to prospective customers. Prospective customers may be sent an introductory communication addressed from the existing customer requesting approval for the business to directly contact the prospective customer. If the prospective customer accepts, the business may then directly contact the prospective customer. In an exemplary embodiment, the existing customer is rewarded with an incentive for providing the information.

### BRIEF DESCRIPTION OF THE DRAWINGS

The drawings described herein are for illustration purposes only and are not intended to limit the scope of the present disclosure in any way. The present invention will become more fully understood from the detailed description and the accompanying drawings herein:

FIG. 1 is a block diagram illustrating major system components in accordance with an exemplary embodiment of the present invention;

FIG. 2 is a simplified illustration showing an exemplary method of the present invention.

### DETAILED DESCRIPTION

The detailed description of various embodiments herein makes reference to the accompanying drawing figures, which show various embodiments and implementations thereof by way of illustration and its best mode, and not of limitation. While these embodiments are described in sufficient detail to enable those skilled in the art to practice the embodiments, it should be understood that other embodiments may be realized and that changes may be made without departing from the spirit and scope of the invention. Furthermore, any reference to singular includes plural embodiments, and any reference to more than one component may include a singular embodiment.

The various embodiments of the method and system for obtaining referrals comprise the features hereinafter described and particularly pointed out in the claims. The following description and the annexed drawings set forth in detail demonstrate certain illustrative embodiments of the disclosure. However, these embodiments are indicative of but a few of the various ways in which the principles disclosed herein may be employed. Other objects, advantages and novel features will become apparent from the following detailed description when considered in conjunction with the drawings.

An exemplary method in accordance with the present invention utilizes past and current customer (hereafter referred to as “customer”) data to obtain referrals from prospective customers. The method uses a web-based application service provider to receive and manage the customer data. A business employing an exemplary method may use the application service provider to contact customers to request information about prospective customers. The information about prospective customers may be received, and an introductory communication addressed to the prospective customer from the customer may be sent. The communication may request permission for the business to directly contact the prospective customer. If permission is granted by the prospect, the business may directly contact the prospective customer.

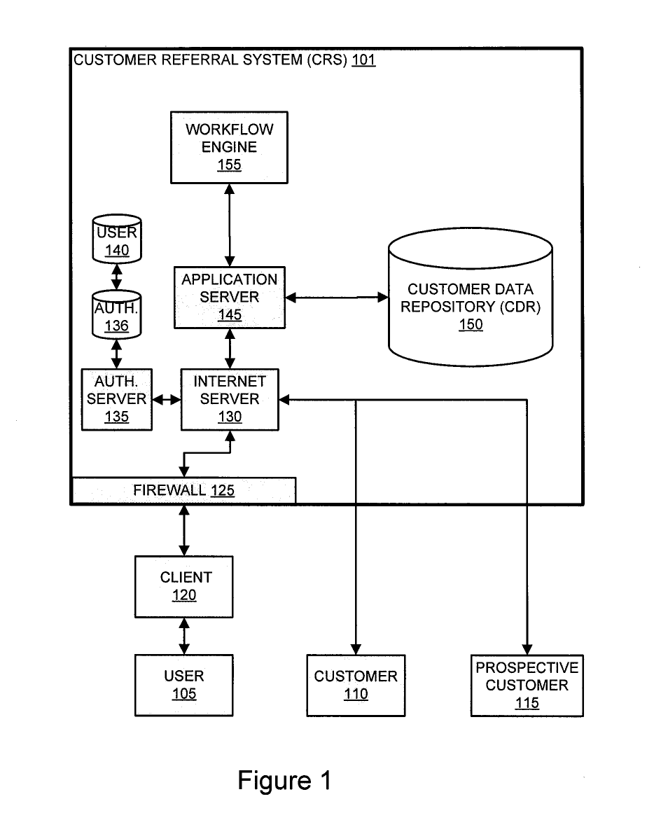

With reference to FIG. 1, in an embodiment, system 100 facilitates a business (e.g., user 105) obtaining referrals from a customer 110 using customer referral system (CRS) 101. In one embodiment, Internet server 130 employs authentication server 145 to validate credentials, assign proper permissions, and retrieve preferences information for authorized users 105 of system 100.

CRS 101 is a framework designed to enable communication between user 105 and customer 110, receiving referral information from customer 110, and communicating with prospective client 115. CRS 101 incorporates web-based application service providers, supports browser-based interfaces and can be easily integrated with existing enterprise solutions. In various embodiments, CRS 101 may include a variety of software modules and/or logic engines, a central database repository an application sever, etc.

In an embodiment, Internet server 130 employs application server 145 to manage various applications and utilities that are utilized by CRS 101. In various embodiments, Internet server 130 interacts directly with the various systems and components disclosed herein. In an embodiment, internet server 130 is a file server. As one skilled in the art will appreciate, in various embodiments Internet server 130 comprises a single physical server, multiple physical servers, multiple logical servers, etc. For example, Internet server 130 may include a plurality of web servers that service requests from users 105, acquire and share data (e.g., via customer data repository 150), etc. System 100 may include any number of computing platforms and databases that may be commonly found within a typical client/server, internet search provider and/or electronic commerce implementation.

Other System 100 components (not shown in FIG. 1) may include, for example, registration systems, management information systems, business information systems, third-party data providers and the like. Each of the systems may be interconnected by a network via any method and/or device described herein. A middleware server (and/or middleware application) may serve as an intermediary between the various systems to ensure appropriate communications between disparate platforms.

CRS 101 may further include one or more of the following: a host server or other computing systems including a processor for processing digital data; a memory coupled to the processor for storing digital data; an input digitizer coupled to the processor for inputting digital data; an application program stored in memory and accessible by the processor for directing processing of digital data by the processor; a display device coupled to a processor and memory for displaying information derived from digital data processed by the processor; and a plurality of databases.

As will be appreciated by one of ordinary skill in the art, one or more of the components of system 100 may be embodied as a customization of an existing system, an add-on product, upgraded software, a stand alone system (e.g., a kiosk), a function of another system 100 component, a distributed system, a method, a data processing system, a device for data processing, a computer and/or a computer program product. Accordingly, individual system 100 components may take the form of an entirely software embodiment, an entirely hardware embodiment, or an embodiment combining aspects of both software and hardware. In one embodiment, system 100 hardware component (e.g. a computer) may include a processor, a memory, a communications interface, a network interface, etc. Furthermore, individual system 100 components may take the form of a computer program product on a computer-readable storage medium having computer-readable program code means embodied in the storage medium. Any suitable computer-readable storage medium may be utilized, including hard disks, CD-ROM, flash memory, optical storage devices, magnetic storage devices, and/or the like. In one embodiment, a system 100 component and/or subsystem comprises a network interface communicating with a memory, the memory communicating with a processor; and the processor, when executing a computer program, configured to accomplish a variety of functions and/or steps.

The system contemplates uses in association with web services (including application service provider, or “asp”), object access and messaging protocols, utility computing, pervasive and individualized computing, security and identity solutions, electronic commerce, autonomic computing, commodity computing, mobility and wireless solutions, open source, biometrics, grid computing and/or mesh computing.

User 105 may include any business that utilizes system 100. In one embodiment, user 105 utilizes CRS 101 to obtain referral information from customer 110. In various embodiments, user 105 interfaces with CRS 101 via any communication protocol, device or method discussed herein or known in the art. For example, user 105 may interact with CRS 101 by way of an Internet browser at client 120.

Client 120 comprises any hardware and/or software suitably configured to facilitate requesting, retrieving, sending, receiving, updating, analyzing, entering and/or modifying data. For example, in one embodiment, client 120 is configured to facilitate input, receipt and/or review of information relating to a customer 110 and prospective customer 115. Client 120 includes any device (e.g., personal computer) and/or software (e.g., browser applications) which communicates (in any manner discussed herein) with CRS 101 via any network discussed herein. Such browser applications comprise Internet browsing software installed within a computing unit or system to conduct searches for products and services, review information, conduct or initiate online transactions and/or facilitate electronic communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that client 120 may or may not be in direct contact with CRS 101. For example, client 120 may access the services of CRS 101 through another server, which may have a direct or indirect connection to Internet server 130.

As those skilled in the art will appreciate, client 120 includes an operating system (e.g., Windows NT, 95/98/2000, OS2, UNIX, Linux, Solaris, MacOS, Android, Palm OS, iPhone OS etc.) as well as various conventional support software and drivers typically associated with computers. Client 120 may include any suitable mobile device (e.g., a mobile device that includes short messaging service (SMS) functionality), phone, personal computer, network computer, workstation, minicomputer, mainframe or the like. Client 120 can be in a home or business environment with access to a network. In an exemplary embodiment, access is through a network or the Internet through a commercially available web-browser software package.

Client 120 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods. It is noted that the network may be implemented as other types of networks, such as an interactive television (ITV) network.

Client 120 may include any number of applications, code modules, cookies, and the like to facilitate interaction with CRS 101 in order to, for example, view files, notices, statements, incentive payment status, transaction fee contribution status, and the like. In one embodiment, client 120 may store user 105 preferences and/or any other information disclosed herein on a hard drive or any other local memory device. Accordingly, client 120 may retrieve and store information within a memory structure of client 120 in the form of a browser cookie, for example. In an embodiment, client 120 retrieves information relating to user 105 from customer data repository (CDR) 150 on establishing a session with Internet server 130. For example, CDR 150 may store a session ID for a user 105.

Firewall 125, as used herein, may comprise any hardware and/or software suitably configured to protect CRS 101 components from users of other networks. Firewall 125 may reside in varying configurations including stateful inspection, proxy based and packet filtering among others. Firewall 125 may be integrated as software within Internet server 130, any other CRS 101 components or may reside within another computing device or may take the form of a standalone hardware component.

Internet server 130 may include any hardware and/or software suitably configured to facilitate communications between client 120 and one or more CRS 101 components. Further, Internet server 130 may be configured to transmit data to client 120 within markup language documents. As used herein, “data” may include encompassing information such as commands, queries, files, data for storage, and/or the like in digital or any other form. Internet server 130 may operate as a single entity in a single geographic location or as separate computing components located together or in separate geographic locations. Internet server 130 may provide a suitable web site or other Internet-based graphical user interface which is accessible by consumers. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix, MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, AJAX (asynchronous JavaScript +XML), active server pages (ASP), PHP, ZEND Framework, common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g., 123.4.56.789). Internet server 130 retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts.

In order to control access to any component of CRS 101, Internet server 130 may invoke an authentication server 135 in response to user 105 submissions of authentication credentials received at Internet server 130 from client 120. Authentication server 135 may include any hardware and/or software suitably configured to receive authentication credentials, encrypt and decrypt credentials, authenticate credentials, and grant access rights according to privileges (e.g., pre-defined privileges) attached to the credentials. The authentication server may grant varying degrees of application and data level access to users based on information stored within a database and/or any other known memory structure.

Workflow engine 155 comprises an automated process execution engine. Workflow engine 155 may comprise one or more software applications, modules or data objects. The software may be any executable code written in any software programming language, such as, for example Java® . For example, in one embodiment, workflow engine 155 reads data from central database repository (CDR) 150 and instantiates a data object (e.g., a Java Bean®) to store the data for use by software modules or other objects.

Authentication database 136 may store information used in the authentication process such as, for example, user identifiers, passwords, access privileges, user preferences, user statistics, and the like. User database 140 maintains user information and credentials for CRS 101 users (e.g., user 105).

CDR 150 is a data repository that is configured to store a wide variety of comprehensive data. While depicted as a single logical entity in FIG. 1, those of skill in the art will appreciate that CDR 150 may, in some embodiments, consist of multiple physical and/or logical data sources. In one embodiment, CDR 150 stores user profile data, customer data, prospective customer data, transaction data, content data, historical data, configuration data, geographic data, schedules, security profiles, audit records, predefined rules, process definitions, financial data, and the like.

One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: user data; customer data; prospective customer data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which orates both hardware and software components of such. Communication among the parties in accordance with the present invention may be accomplished through any suitable communication channels, such as, for example, a telephone network, an extranet, an intranet, Internet, point of interaction device (e.g., point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, modals (e.g., popup windows), prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, modal, and/or the like. Likewise, there are a number of methods available for modifying data in a web page such as, for example, free text entry using a keyboard, selection of menu items, check boxes, option boxes, and/or the like.

Referring again to FIG. 1, in one embodiment, when user 105 logs onto an application (such as, for example, a business logging in to contact customers and obtain referrals, or a customer 110 logging in to provide information about referrals) Internet server 130 may invoke application server 145. Application server 145 invokes logic in the workflow engine 155 by passing parameters relating to the user's 105 data input. CRS 101 manages requests for data from workflow engine 155 and communicates with system 101 components. Transmissions between user 105 and Internet server 135 may pass through a firewall 125 to help ensure the integrity of CRS 101 components. Practitioners will appreciate that the invention may incorporate any number of security schemes or none at all. In one embodiment, Internet server 130 receives requests from client 120 and interacts with various other system 100 components to perform tasks related to requests from client 120.

Internet server 130 may invoke an authentication server 135 to verify the identity of user 105 and assign roles, access rights and/or determine permissions for user 105. In order to control access to the application server 145 or any other component of CRS 101, Internet server 130 may invoke an authentication server 135 in response to user 105 submissions of authentication credentials received at Internet server 130. When a request to access system 100 is received from Internet server 130, Internet server 130 determines if authentication is required and transmits a prompt to client 120. User 105 enters authentication data at client 120, which transmits the authentication data to Internet server 130. Internet server 130 passes the authentication data to authentication server which queries the user database 140 for corresponding credentials. When user 105 is authenticated, user 105 may access various system 100 applications, functionality and modules along with their corresponding data sources (e.g., CDR 150).

System 100 enables user 105 (e.g., a business seeking referrals), to utilize a web-based application server to manage customer data and communicate with customer 110 and prospective customer 115. CRS 101 provides a platform for businesses (e.g., users 105) and customers 210 to interact with each other. The system allows user 105 to more effectively solicit referral information from customer 110, and to more effectively offer and provide incentives for customer 110 to provide such information.

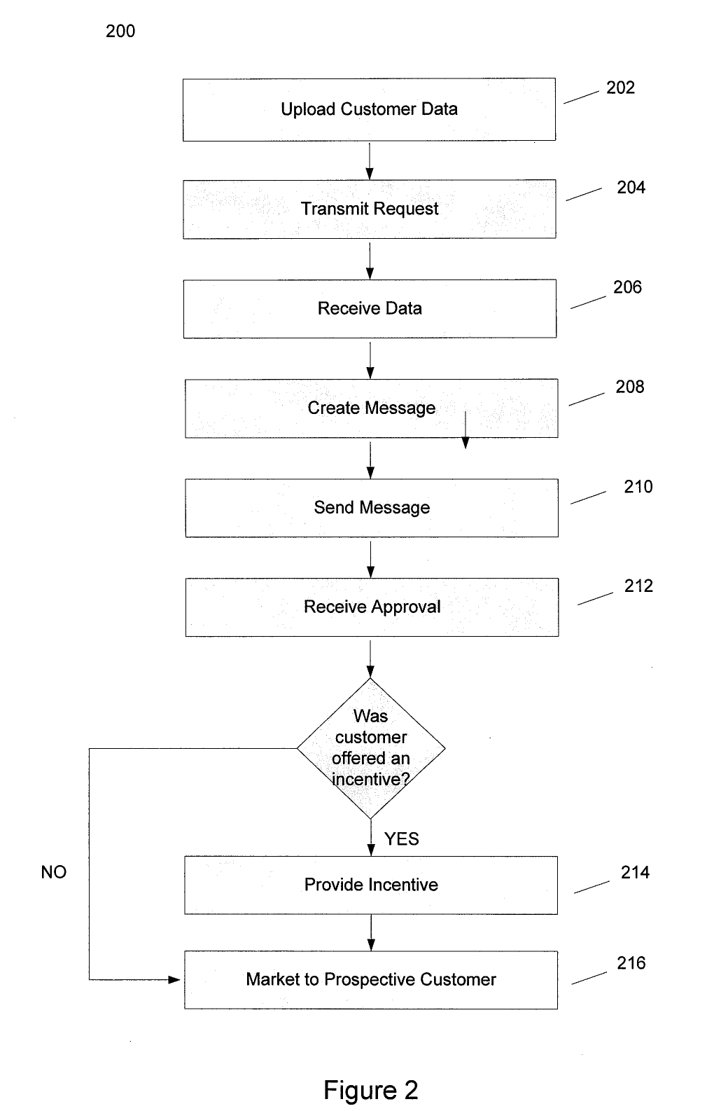

With reference to FIG. 2, a method 200 in accordance with the present invention is illustrated in a flowchart diagram. Method 200 can facilitate obtaining prospective customer referrals by managing and utilizing data from customers.

In accordance with various exemplary embodiments of the present invention, method 200 includes an upload customer data step 202. Upload customer data step 202 may comprise providing customer data to a web-based application service provider (“ASP”). Upload customer data step 202 may comprise providing customer data including, but not limited to, customer names, addresses, telephone numbers, website addresses, email addresses, company names, professional designations, credit card information, and any other data associated with customers. The user utilizing the method may determine what types of information to provide to the ASP.

In various exemplary embodiments, upload customer data step 202 comprises uploading a file containing customer data. In one embodiment, the user may upload a single file, such as an excel or vcf file, which contains the desired customer data. In another embodiment, the user may synchronize a program containing customer data, such as Microsoft Outlook, with an ASP to upload the customer data. In yet another embodiment, the user may manually enter customer data to an ASP.

Upload customer data step 202 may comprise determining a list of customers. The user may establish particular criteria for selecting customer data to upload. For example, the user may select customers based on information categories such as address, company name, professional designation, and any other information category associated with customers. Once the customer list is determined, data of each customer on the list may then be uploaded to an ASP.

In accordance with various exemplary embodiments of the invention, method 200 includes a transmit request step 204. The user may create and send an information request to any customers. In an exemplary embodiment, transmit request step 204 transmits the information request to all customers whose information was uploaded in upload customer data step 202. In another exemplary embodiment, the user determines to whom the information request will be transmitted. For example, the user may select customers to transmit the information request to based on information categories such as address, company name, professional designation, and any other information category associated with customers.

In an exemplary embodiment of the invention, the user creates an information request that specifies a particular number of prospective customers the user would like the customer to provide. For example, the user may request that customers provide information relating to between 1 and 10 prospective customers, though any number requested by the user is in accordance with the present invention.

In various embodiments, transmit request step 204 creates an information request which comprises a pre-prepared message. The pre-prepared message may comprise a template which receives customer information and integrates it into the body of the pre-prepared message. The user may provide the name of the customer, as well as other required information such as email address or mailing address, to the template. The pre-prepared message may include options such as whether or not an incentive is provided, as well as any other information the user may determine to be relevant to the information request.

In various exemplary embodiments, such relevant information may include any regulatory or compliance information required. For example, an email information request may be required to comply with anti-spam regulations, such as the Controlling the Assault of Non-Solicited Pornography and Marketing Act of 2003 (“CAN SPAM Act”). As a result, the user may include information such as their business name and address, and any other regulatory or compliance information required.

In an exemplary embodiment of the invention, the information request includes a provision allowing customers to opt-out of participating in any referral-based marketing. For example, the information request may include a link which, when activated, returns an email to user indicating that customer does not want to participate in any referral-based marketing. If the customer chooses to opt-out, the user will discontinue any referral-based marketing efforts to the customer.

In an exemplary embodiment of the invention, the transmit request step 204 creates an information request which includes an offer of an incentive to customers to provide prospective customer information. This incentive may be provided after the customer provides a successful prospective customer. A successful prospective customer may be a prospective customer who grants the user approval to directly contact them. In other embodiments, the incentive may be provided to the customer for each prospective customer referred. This incentive may be a monetary incentive, discounted goods or services, or any other incentive the user may offer to the customer.

In an exemplary embodiment of the invention, the information request provides customer with means to provide prospective customer information to user. This may include a link that directs customer to the web-based application service provider. Other embodiments may provide an email address which the customer may reply to. In still other embodiments, the customer may be provided a physical address to which they send the prospective customer information. Any means in which a customer may provide information related to prospective customers to the user is in accordance with the present invention.

In an exemplary embodiment of the present invention, transmit request step 204 creates an information request which comprises an email. In various other embodiments, the information request comprises a letter designed to be sent via postal mail. In various other embodiments, the information request comprises a telephone call, which may be made by a live operator or an automated system. Still other embodiments comprise a voice-over-internet protocol call. As one skilled in the art will appreciate, any manner in which the transmit request step 204 may transmit the information request to a customer is in accordance with the present invention.

In accordance with various exemplary embodiments of the invention, method 200 includes a receive data step 206. Customers may provide information to the user in response to the information request of transmit request step 204, which is received by receive data step 206. Information received in received data step 206 may include prospective customer names, addresses, telephone numbers, website addresses, email addresses, company names, professional designations, credit card information, and any other data associated with prospective customers.

In an exemplary embodiment, as discussed above, customer utilizes a link provided in the information request to directly access the application service provider. The customer may then directly provide the information of prospective customers to the application service provider. However, any manner in which receive data step 206 may receive data from customer relating to prospective customers is in accordance with the present invention.

In accordance with various exemplary embodiments of the invention, method 200 includes a create message step 208. A message may be created to request approval to contact prospective customers. For example, after receiving prospective customer information from receive data step 206, create message step 208 may utilize the prospective customer information to create a personalized message to each prospective customer.

In an exemplary embodiment, a message is created using a pre-prepared message. The pre-prepared message may comprise a message template. The user may provide to the message template prospective customer information including, but not limited to, prospective customer name, mailing address, email address, and any other information useful in creating a message to prospective customer. The message template then integrates the prospective customer data into the body of the pre-prepared message.

In various embodiments, create message step 208 creates a message that provides prospective customer a manner in which to respond to the message. For example, the message of create message step 208 may include a link to the application service provider. If an email message is created by create message step 208, the email message may include a return address which the prospective customer may use to indicate approval. If a letter is created by create message step 208, the letter may include a portion to be returned to user, the portion permitting prospective customer to indicate approval. Any manner in which create message step 208 may create a message that provides prospective customer a manner in which to indicate approval to the user is in accordance with the present invention.

In various exemplary embodiments, create message step 208 creates a message that is addressed from the customer who provided the prospective customer information. For example, if a customer provides information of a friend as a prospective customer, create message step 208 may create a message addressed from the customer to the friend. In other exemplary embodiments, the message may be addressed from the user and contain an introductory message from the customer who provided the prospective customer information.

In various exemplary embodiments, create message step 208 may create a message which includes any required regulatory or compliance information. For example, an email message may be required to comply with anti-spam regulations, such as the CAN SPAM Act. As a result, the user may include information such as their business name and address, and any other regulatory or compliance information required.

In an exemplary embodiment of the invention, the message includes a provision allowing prospective customers to opt-out of participating in any referral-based marketing. For example, the message may include a link which, when activated, returns an email to user indicating that prospective customer does not want to participate in any referral-based marketing. If the prospective customer chooses to opt-out, the user will discontinue any referral-based marketing efforts to them.

In various exemplary embodiments, create message step 208 creates an email message. In other embodiments, create message step 208 may create a letter designed to be sent by postal mail. That said, as one skilled in the art will appreciate, any manner in which create message step 208 may create a message to a prospective customer is in accordance with the present invention.

In accordance with various embodiments of the invention, method 200 may include a send message step 210. As discussed in relation to create message step 208, send message step 210 may send a message via email. In other embodiments, the message may be sent as a letter via postal mail. As one skilled in the art will appreciate, any manner of sending the message utilized by send message step 210 is in accordance with the present invention.

In accordance with various embodiments of the invention, method 200 includes a receive approval step 212. After receiving the message sent by send message step 208, receive approval step 212 may receive approval as indicated by prospective customer. For example, prospective customer may transmit an email, using information provided by the user in create message step 208, to indicate approval. In various embodiments, prospective customer sends, via postal mail, a letter, postcard, return receipt, or any other physical document which indicates approval. In other embodiments, prospective customer calls user, via telephone or voice-over-internet-protocol, to indicate approval.

In a preferred embodiment, prospective customer indicates approval through the application service provider by utilizing a link to the application service provider. As discussed in create message step 208, a link may be included in the message created by create message step 208 which would permit prospective customer to directly access the application service provider and indicate approval. However, any manner in which prospective customer may indicate approval to user is in accordance with the present invention.

In accordance with various embodiments of the invention, method 200 includes an optional provide incentive step 214. Optional provide incentive step 214 may provide an incentive to a customer. In an exemplary embodiment, provide incentive step 214 provides customer with an incentive after prospective customer indicates approval to user. In other embodiments, provide incentive step 214 provides an incentive to customer after customer provides a specified number of prospective customers.

In an exemplary embodiment, provide incentive step 214 provides a monetary incentive to customer electronically. For example, provide incentive step 214 may comprise utilizing a web-based payment provider, such as PayPal, to provide payments directly to customer. In various embodiments, provide incentive step 214 may comprise utilizing a web-based gift card provider, such as www.giftcertificates.com, to provide a web-based gift card to customer. In various embodiments, provide incentive step 214 comprises utilizing an online merchant account to provide a direct payment to customer. In other embodiments, provide incentive step 214 comprises sending a check via postal mail to customer. As one skilled in the art will appreciate, any manner of providing a monetary incentive utilized by provide incentive step 214 is in accordance with the present invention.

In other embodiments, provide incentive step 214 provides a non-monetary incentive to customer. Such non-monetary incentives may include discounts on goods or services provided by user or credit which may be used to purchase goods or services provided by user. Any type of incentive, whether monetary or non-monetary, provided by provide incentive step 214 is in accordance with the present invention.

In accordance with various embodiments of the invention, method 200 includes a market to prospective customer step 216. In various embodiments, after receive approval step 212 has successfully received approval from prospective customer, the user directly contacts the prospective customer. Market to prospective customer step 216 may comprise providing a direct contact to prospective customer. In various embodiments, market to prospective customer step 216 comprises sending marketing materials to prospective customer via email. In other embodiments, market to prospective customer step 216 comprises sending marketing materials to prospective customer via postal mail.

In various embodiments, market to prospective customer step 216 comprises contacting prospective customer via telephone. In other embodiments, step 216 comprises contacting prospective customer via voice-over-internet protocol. Any manner in which market to prospective customer step 216 may contact prospective customer is in accordance with the present invention.

The present invention has been described above with reference to a number of exemplary embodiments. It should be appreciated that the particular embodiments shown and described herein are illustrative of the invention and its best mode and are not intended to limit in any way the scope of the invention. Those skilled in the art having read this disclosure will recognize that changes and modifications may be made to the exemplary embodiments without departing from the scope of the present invention. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

1. A method of obtaining new customer referrals, comprising:
providing data relating to an existing customer to a web-based application service provider;
transmitting a new customer information request to said existing customer;
receiving data relating to a prospective customer from said existing customer;
creating a message from said existing customer to said prospective customer requesting permission for a user to send a message to said prospective customer;
sending said message to said prospective customer; and
receiving approval from said prospective customer for said user to directly solicit said prospective customer.

2. The method of claim 1, wherein said step of providing data comprises providing data for multiple existing customers.

3. The method of claim 1, wherein the step of sending said message to said prospective customer further comprises providing said prospective customer a link to said web-based application service provider.

4. The method of claim 3, wherein said step of receiving approval from said prospective customer further comprises said prospective customer using said link to indicate said approval.

5. The method of claim 1, wherein the step of transmitting information requests to said existing customer further comprises offering said existing customers an incentive to provide data of said prospective customer.

6. The method of claim 5, wherein said incentive is forwarded to said existing customer after said existing customer provides said data of a prospective customer.

7. The method of claim 1, wherein said step of creating a message further comprises selecting a message template from a number of pre-prepared message templates.

8. The method of claim 7, wherein said step of creating a message further comprises identifying the type of service to be offered to said prospective customer.

9. The method of claim 8, wherein said step of creating a message further comprises adding to the message compliance and regulatory information.

10. The method of claim 1, wherein said step of transmitting a new customer information request further comprises requesting information for multiple prospective customers.

11. A system comprising a tangible, non-transitory memory communicating with a processor for managing customer data, the tangible, non-transitory memory having instructions stored thereupon that, in response to execution by a computer-based system, cause the computer-based system to perform operations comprising:
transmitting, by the processor, a new customer information request to an existing customer;
receiving, by the processor from a said exiting customer, data relating to a prospective customer;
creating, by the processor, a message from said existing customer to said prospective customer requesting permission for a user to send a message to said prospective customer;
sending, by the processor, said message to said prospective customer; and
receiving, by the processor, approval from said prospective customer for said user to directly solicit said prospective customer.

12. The system of claim 11, wherein the step of transmitting, by the processor, a new customer information request to an existing customer further comprises offering said existing customer an incentive to provide data of said prospective customer.

13. The system of claim 12, wherein said incentive is forwarded to said customer after receiving said data relating to a prospective customer.

14. The system of claim 11, wherein said step of creating, by the processor, a message further comprises creating said message from one of a number of pre-prepared message templates.

15. The system of claim 14, wherein said step of creating, by the processor, a message further comprises identifying the type of service to be offered to said prospective customer.

16. The system of claim 15, wherein the step of creating, by the processor, a message further comprises adding to the message compliance and regulatory information.

17. The system of claim 11, wherein said step of transmitting, by the processor, a new customer information request further comprises requesting information for multiple prospective customers.
